(19) United States
(12) Patent Application Publication
(10) Pub. No.: US 2003/0133637 A1
(43) Pub. Date: Jul. 17, 2003

(54) Lithium niobate waveguide device incorporating Li-trapping layers

(76) Inventors: Zhenan Bao, Jersey City, NJ (US); Christopher A. Bower, New Providence, NJ (US); Sungho Jin, Millington, NJ (US); Kevin Cyrus Robinson, Zionsville, PA (US); Yiu-Man Wong, Wescosville, PA (US); Wei Zhu, Warren, NJ (US)

Correspondence Address: HARNESS, DICKEY & PIERCE, P.L.C., P.O. BOX 8910, RESTON, VA, 20195, US

(21) Appl. No.: 10/050,244

(22) Filed: Jan. 16, 2002

(51) Int. Cl. G02B 6/10

(52) U.S. Cl. 385/2; 385/129

(57) ABSTRACT

An electrooptic device and method for making the same, including one or more of substrate, a buffer layer, a charge dissipation layer, and electrodes. An F⁻ containing active trapping layer is deposited at the substrate/buffer interface, within the buffer layer, and/or on top of the buffer layer. The active F⁻ ions in the F⁻ containing active trapping layer react with positive ions, such as Li⁺ from the substrate to form stable compounds such as LiF. Porous material such as carbon nanotubes may be used in place of or in addition to the F⁻ containing active trapping layer. The reduced number of Li⁺ ions reduces the DC drift of the associated electrooptic device. The profile of the implanted ions may be adjusted to control and/or optimize the properties of the electrooptic device. Fluorine is particularly advantageous because it also lowers the dielectric constant thereby facilitating higher frequency operation.

### TECHNICAL FIELD

The present invention relates to waveguide type optical devices, in particular, lithium-niobate-based, high-speed optical signal modulators and methods of making the same.

### BACKGROUND ART

Waveguide optical devices may utilize an electro-optical crystal, such as an LiNbO₃ or an LiTaO₃ substrate in order to modulate optical signals for high-speed telecommunication systems using optical fiber networks. For optical modulators, an electric field is applied to an optical waveguide path formed inside a surface of an electro-optical crystal substrate such as LiNbO₃ or LiTaO₃, which in turn alters the refractive index of the optical waveguide path inducing switching of optical signals traveling inside the optical waveguide path, as well as modulating the phase and intensity of the optical signals. FIG. 1(a) schematically illustrates a cross-sectional diagram of such a single drive LiNbO₃ modulator device 100. The voltage V applied to the two electrodes 10, 12 separated by a gap G produces an electric field line E, which intersects the optical waveguide path 14.

In a single drive LiNbO₃ modulator device, such as the one illustrated in FIG. 1(a), a transparent dielectric film or buffer layer 16, having a slightly lower refractive index than that of the optical waveguide path 14, is often sandwiched between the optical waveguide path 14 and the electrodes 10, 12. The buffer layer 16 reduces the undesirable absorption of light in the optical waveguide path 14 by the electrode metal, and also helps to match velocities between the RF and optical signals traveling along the optical waveguide path 14. When an electrode 10, 12 is formed on the buffer layer 16 and the voltage V is applied to the electrode 10, 12, the electric field E is applied to the optical waveguide path 14 formed in the LiNbO₃ crystal substrate 18 and the refractive index of the optical waveguide path 14 changes in proportion to the intensity of the electric field E. As a result, functions, such as switching and modulation of optical signals may be performed. Therefore, accurate control of the electric field E applied to the optical waveguide path 14 is important in assuring reliability of devices 100 of this type.

Waveguide devices utilizing the above-described electric field-based modulation of an electro-optical crystal substrate include optical switches, modulators, branching filters, and polarized wave controllers. Such devices are described, for example, in “Optical Fiber Telecommunications”, Volume IIIB, edited by I. P. Kaminow and T. L. Koch, page 404, Academic Press, New York, 1997, and “Lithium Niobate for Optoelectronic Applications” by J. Saulner, Chap. CII in Materials for optoelectronics, edited by Maurice Quilec, 1996.

FIG. 1(b) illustrates an exemplary dual drive prior art LiNbO₃ modulator device 200. The device 200 is based on a Mach-Zehnder-type optical modulator design which is useful for ultra-high speed optical communication. The modulator device 200 is a dual-drive, traveling wave, y-branch type design, which is desirable for ensuring high modulation bandwidth and a low drive voltage operation. The modulator 200 of FIG. 1(b) allows an electrical drive signal to propagate along a transmission line along a direction of the optical waveguide path 14. A long interaction length between the optical and electrical signal enables the drive voltage V to be kept relatively low. One or both of the input optical fiber 1 and the optical output fiber 9 may be surrounded by a glass capillary 8. The electrodes 10, 12 may be made of gold strips and the buffer layer may be a sputter deposited SiO₂ layer.

A thin charge-dissipating-layer (CDL layer) including a slightly conductive material (possibly Si oxynitride compound based) may optionally be added between the electrode 10, 12 and the buffer layer 16 so as to reduce the electric charge accumulation/drift on the buffer layer 16 surface, which can cause electric field control variations.

In FIG. 1(b), the LiNbO₃ crystal substrate 18 is cut along a certain crystallographic orientation, e.g., x-axis or z-axis, depending on the mode of operation and specific application. If the cut is made in such a manner that an x-axis of the crystal axis extends in a longitudinal direction of a chip and a z-axis extends in the direction of thickness, then the desirable electro-optical coefficient x₃₃ is utilized. A semi-circular optical waveguide path 14 having a greater refractive index than that of the substrate 18 and having a diameter of typically several micrometers (similar to the core size of optical fibers 1,9) is formed on a surface of the substrate 18 by either localized ion implantation of titanium or by deposition of Ti metal and controlled thermal diffusion into the waveguide regions. For the purpose of preventing absorption of light propagating through the optical waveguide path 14 by the electrode 10, 12, the silicon dioxide (SiO₂) layer 16 having a specific dielectric constant of ˜4.0 and a refractive index of about ˜1.45 is deposited to a thickness of e.g., ˜0.5 micrometers over the entire surface of the waveguide substrate 18 by a film formation technique, such as sputtering or electron beam deposition, thereby forming the buffer layer 16. The signal electrodes 10 and 12 including a thin gold (Au) film having a width of several micrometers and a thickness of ˜10 micrometers, for example, are formed by vacuum deposition and plating at positions on the surface of the buffer layer 16 corresponding to the optical waveguide path 14. As illustrated, the output optical fiber 9 may be aligned and locked in position by glass capillary fixture 8.

In operation, although an externally applied DC voltage is maintained constant, the characteristics of the outgoing light signal from the 100 and 200 vary with time. Such a phenomenon is referred to as a “DC drift” problem in LiNbO₃ waveguide devices.

This common and undesirable, time-dependent drift of the optical signal characteristics, should be either eliminated or minimized. Movement of ions, such as the Li⁺ ions within the buffer layer 16 (that originated inside the LiNbO₃ crystal 18 or on its surface, but migrated to the buffer layer 16 as a result of fabrication, usually during the high temperature annealing step for Ti diffusion) is considered to be one of the causes of DC drift. As the ions move or accumulate locally, the distribution of the DC electric field within the modulator device 100 or 200 changes over time and DC drift occurs. This is described in S. Yamata et al., “DC Drift Phenomenon in LiNbO3 Optical Waveguide Devices”, Japanese Journal of Applied Physics Vol. 20, No. 4, April 1881, page 733.

There are several known solutions to this problem, many focusing on immobilizing the movable ions inside and on the surface of the crystal substrate 18 in order to control DC drift. Some of these known solutions are described below.

U.S. Pat. No. 5,680,497 discloses an optical waveguide device which includes a LiNbO₃ substrate 1 and a layer 3. The layer 3 is made of a transparent dielectrical insulator of a mixture between silicon dioxide and an oxide of at least one element selected from the group consisting of the metal elements of the Groups III-VIII, Ib, and IIb elements, for example, about 5-10 atomic % of In₂O₃. The doping of the SiO₂ buffer layer with other oxides such as In₂O₃ appears to help tie up or slow down the movement of the Li⁺ ions. U.S. Pat. No. 5,479,552 discloses a waveguide-optical device which includes an LiNbO₃ or LiTaO₃ substrate, a blocking layer, and buffer layer of SiO₂. The blocking layer, including Si, Si₃N₄, SiON, or MgF₂ is placed between the substrate and the buffer layer. The blocking layer blocks the diffusion of Li₊ ions from the substrate.

Japanese Kokai Patent Application No. Hei 6-75195 discloses an optical controller including an LiNbO₃ or LiTaO₃ substrate and a SiO₂ buffer. A blocking layer, of low ionic conductance, is also placed between the substrate and the buffer. Again, the blocking layer may include Si, Si₃N₄ and MgF₂. The trapping layer includes SiO₂ doped with phosphorus. The trapping layer and blocking layer may be used separately or in combination.

Japanese Kokai Patent Application No. HEI 5-113513 discloses a waveguide optical device which includes an LiNbO₃ substrate doped with a Group V element, such as Cl and/or P.

“Reduction of DC Drift in LiNbO₃ Waveguide Electro-optic Device by Phosphorus and SiO₂ Buffer Layer” by Suhara et al. discloses a LiNbO₃ substrate with a buffer layer of SiO₂ doped with phosphorus.

FIGS. 2(a) and (b) schematically illustrate two exemplary prior art LiNbO₃ modulator devices, with and without blocking layers. FIG. 2(a) schematically illustrates a prior art modulator structure of a single drive type, which includes an LiNbO₃ substrate 18, a buffer oxide layer 16, a charge dissipation layer 17, an optical waveguide 14, and electrodes 10, 12. FIG. 2(b) schematically illustrates a prior art modulator structure, which further includes a blocking layer 23. The blocking layer 23 may be made of Si₃N₄, SiON, or MgF₂. In the arrangement of FIGS. 2(a) and 2(b), the LiNbO₃ substrate 18 is a single crystal z-cut substrate, approximately 700 μm high, where n=2.14, ε_{zz}=30, and r33=31 pm/V, the SiO2 buffer oxide layer 16 is approximately 1 pm thick and indium doped, where n=1.45 and ε=4, the charge dissipation layer 17 is approximately 80 nm thick, the electrode 10 is a gold ground electrode, 15-30 μm high, the electrode 12 is a gold hot line electrode, 15-30 μm high, 6-10 pm wide, and 15-30 μm from the ground electrode 10, and the optical waveguide path 14 is Ti diffused, where n=2.15 and the loss is approximately 0.2 dB/cm.

As discussed earlier, the device shown in FIG. 2(a) without an Li-ion blocking layer suffer from DC drift in its optical output signal due to Li-ion movement in the buffer layer 16 under the influence of the applied electrical field. Although the use of blocking layers of Si, Si₃N₄, SiON and MgF₂ shown in FIG. 2(b) might possibly reduce the diffusion rate of Li ions from the LiNbO₃ substrate to the oxide buffer layer, the amount of Li ions in the buffer layer 16 likely remains high, and their movement in an electric field is not hindered. Therefore, passive blocking of Li ions by inserting a structurally different layer, such as blocking layer 23 between the LiNbO₃ substrate 18 and the oxide buffer layer 16 is unlikely to fundamentally solve the DC drift problem.

### SUMMARY OF THE INVENTION

The present invention reduces DC drift in conventional electrooptic devices by providing an electrooptic device and method for making the same, wherein Li-ions are actively trapped (instead of passively blocked) where active indicates via chemical bonding and/or surface adsorption. More specifically, F-containing materials are used to chemically trap Li through the formation of the highly stable compound LiF. The active F⁻ ions react with positive ions, such as Li⁺ to form stable compounds such as LiF. The reduced number of Li⁺ ions reduces the DC drift of the associated electrooptic device. Once Li is chemically bonded to F, it no longer exists as a free, positively charged ion, and the electrical field will have no effect on its movement. The F-containing inorganic materials may include fluorinated Si oxide, Si nitride or Si oxynitride based materials, and the F-containing organic materials (defined as materials containing C, H and O only) may include amorphous fluorinated carbons, and fluorinated polymers. They may be deposited at the substrate/buffer interface, within the buffer layer, and/or on top of the buffer layer. The use of F-containing materials is particularly advantageous because they have lower dielectric constrants, thereby facilitating high frequency operation.

The present invention also reduces DC drift in conventional electrooptic devices by providing an electrooptic device and method for making the same, wherein a porous material, such as carbon nanotubes that are known to have a large Li absorbing capacity, are used to trap Li ions and prevent their movement. A porous material is defined as any material having naturally occurring pores or any material in which pores may be created by disturbing surrounding structure. Such materials include but are limited to polyhedral oligomeric silsequioxanes (POSS), zeolites, cyclomacroethers, porphyrins, foldamers, cyclodextrins, nanotubes and mixtures thereof. The porous material may be used in place of or in addition to the F-containing active trapping layer.

### BRIEF DESCRIPTION OF THE DRAWINGS

The nature, advantages and various additional features of the invention will appear more fully upon consideration of the illustrative embodiments now to be described in detail with the accompanying drawings. In the drawings:

FIGS. 1(a) and (b) schematically illustrate the basic structure and operation principle of exemplary, prior art single and dual drive LiNbO₃ modulators, respectively;

FIGS. 2(a) and (b) schematically illustrate cross-sectional diagrams depicting (a) a prior art LiNbO₃ modulator without any blocking or trapping layer, and (b) a prior art LiNbO₃ modulator with blocking layer of Si, Si₃N₄, SiON, or MgF_{2.}

FIGS. 3(a), (b) and (c) schematically illustrate embodiments of the F-containing Li-trapping layer in a LiNbO₃ modulator structure according to exemplary embodiments of the present invention.

FIG. 4 illustrates the compositional depth profile across the SiO₂ buffer layer for devices with and without an organic Li-trapping layer according to exemplary embodiments of the present invention.

FIGS. 5(a) and (b) schematically illustrate embodiments of porous Li-trapping layer in LiNbO₃ modulator structure according to exemplary embodiments of the present invention.

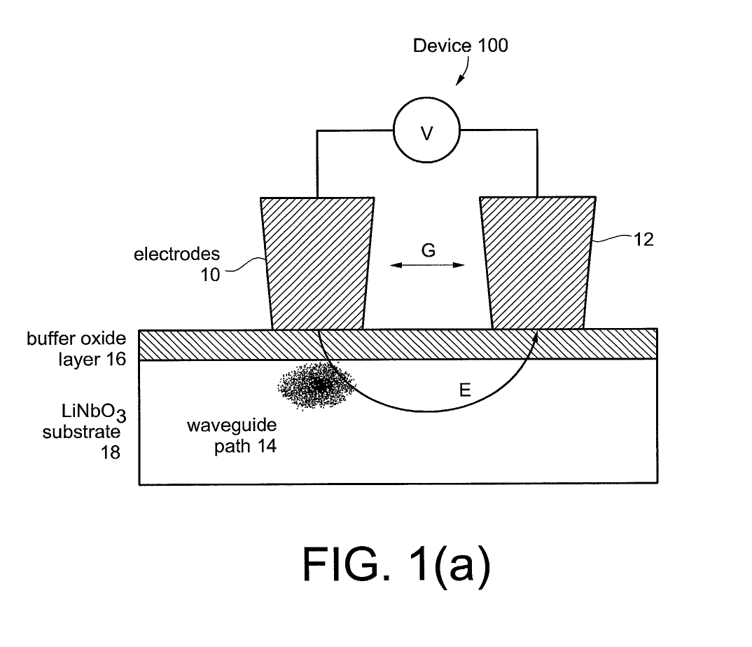

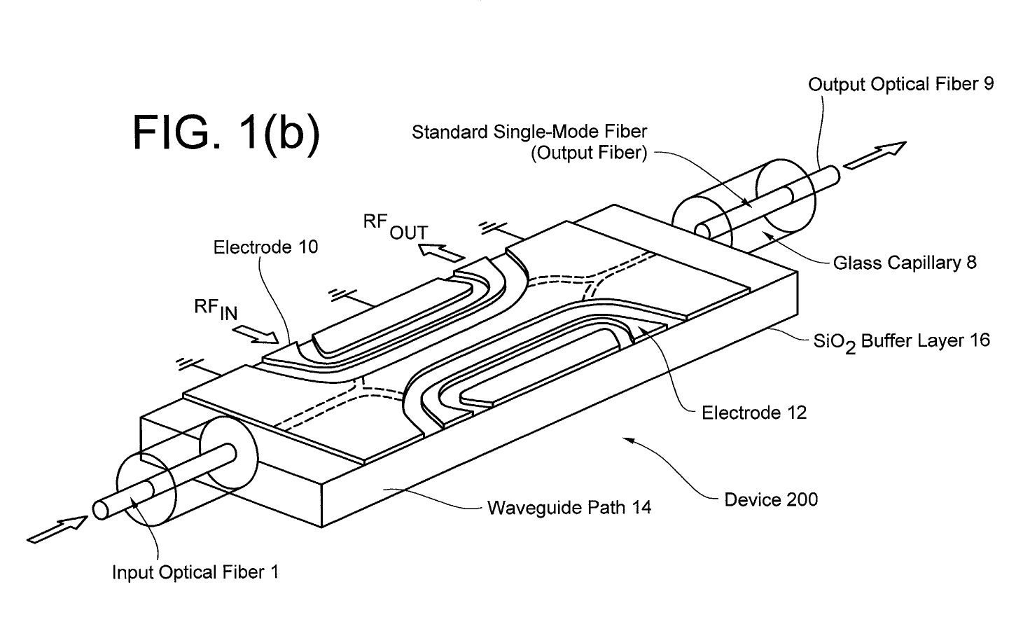

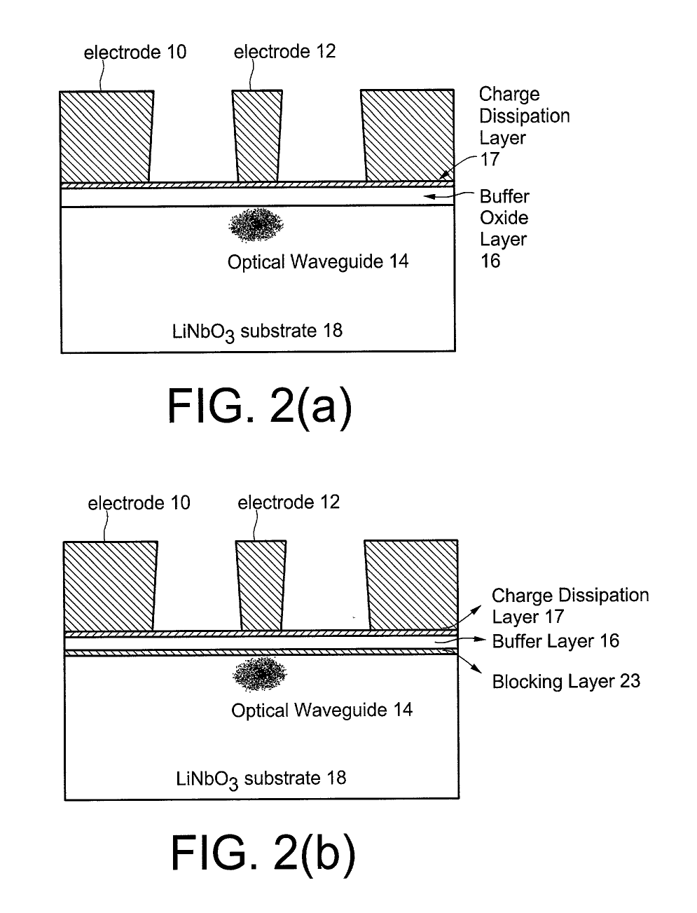

It is to be understood that the drawings are for purposes of illustrating the concepts of the invention and are not to scale.

### DETAILED DESCRIPTION OF THE PREFERRED EMBODIMENTS

The present invention uses F⁻ containing material, to chemically trap Li⁺ ions by forming a stable LiF compound that is unlikely to move under an electric field, because of its electrical neutrality. Examples of such a F-containing inorganic layer include CVD (chemical vapor deposition) deposited fluorinated Si oxide, Si nitride or Si oxynitride based materials. Examples of such a F-containing organic layer include Teflon™ AF (from Du Pont, (CF₃)ₙ) fluorinated amorphous carbon (a-C:F), PFCB (perfluorocyclobutene

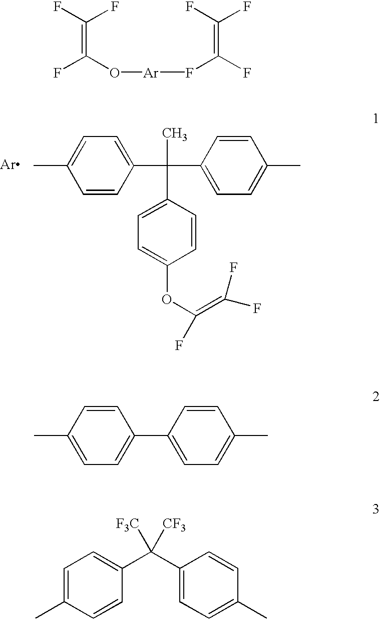

and CYTOP (from Asahi Glass Co.,

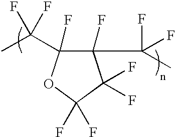

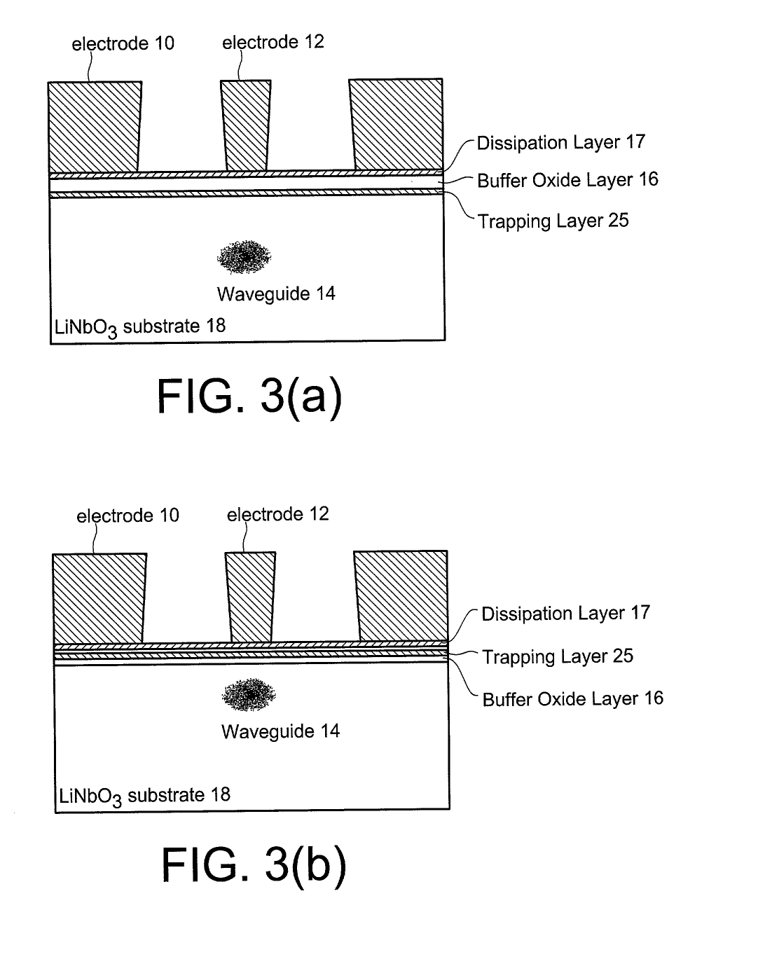

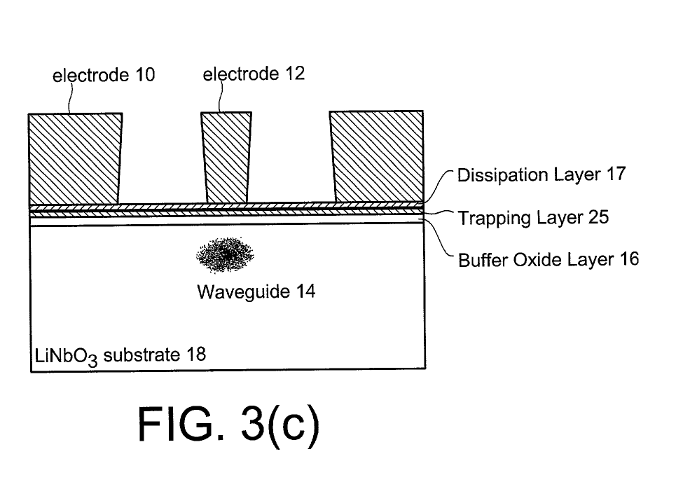

FIGS. 3(a)-(c) illustrate various embodiments of the present invention, including an LiNbO₃ substrate 18, a buffer oxide layer 16, a charge dissipation layer 17, an optical waveguide 14, a trapping layer 25 and electrodes 10, 12. As illustrated in FIGS. 3(a)-(c), the F⁻ containing organic material layer 25 can be placed either at the buffer layer/LiNbO₃ interface (FIG. 3(a)), within the buffer layer (FIG. 3(b)) or at the surface of the buffer layer (FIG. 3(c)). When Li⁺ and F⁻ atoms are present together, they form a very stable compound LiF due to a strong thermodynamic driving force. The heat of formation (ΔH_{f}) for the reaction of Li and F to produce LiF is a very large negative value, i.e., about −290 Kcal/mole at 0K. This is much greater than the ΔH_{f} values at 0° K for the formation of SiF₄ (−185 Kcal/mole), CF₄ (−219 Kcal/mole), CHF₃ (−163 Kcal/mole), CH₂F₂ (−105 Kcal/mole) and Li₂O (−140 Kcal/mol). Therefore, Li⁺ ions, once diffused into the F-containing organic trapping layer, will grab F atoms that are bonded to carbon and react to form LiF. Thus the tendency of LiF formation and Li⁺ ion gettering effect by fluorine is very strong. Once the LiF compound is formed, it is difficult to separate Li⁺ from the LiF compound, thus the previously mobile Li⁺ ions are converted to immobile or significantly less mobile LiF molecules that are electrically neutral. On the contrary, F in the MgF₂ blocking layer disclosed in the prior art will not easily react with Li⁺ ions to form LiF, because the thermodynamic stability (or the heat of formation) of MgF₂ is similar to that of LiF.

The organic layers of Teflon™, PFCB and CYTOP can be applied via a spin-on process. For example, PFCB can be dissolved into xylenes (e.g. 20 wt %), the solution of which can be spin-coated (200 rpm for 60 sec, for example) onto a substrate surface. The substrate can then be heated to 250° C. for 30 minutes to convert the film into a cross-linked network. Similarly, a solution of CYTOP (3 mg/ml) in perfluorotributylamine can be spin-coated, and the solvent can be removed by heating at 100° C. for 5 minutes. Teflon™ dissolves in FC77 and other perfluorinated solvents and can be spin-coated in a similar fashion. Other solution-soluble semifluorinated polymers can also be used.

The fluorinated amorphous carbon can be applied via chemical vapor deposition from source compounds of hydrocarbons (such as CH₄, C₂H₂) and fluorocarbons (such as CF₄, C₂F₆, C₄F₈). The fluorinated amorphous carbon can also be deposited by sputtering from a solid fluorocarbon target (such as Teflon™) or in a reactive sputtering environment in which a carbon target is sputtered in the presence of fluorine-containing background gases such as F₂, CF₄, C₄F₈, SiF₄, and SF₄. Ion beam deposition can similarly be used to make such a-C:F films. The fluorine concentration in these a-C:F films can be easily adjusted in a wide range, from <5 atomic % up to 60 atomic %, by manipulating process variables.

These F-containing, Li-ion trapping organic layers are preferred to be deposited at the oxide buffer/LiNbO₃ substrate interface as shown in FIG. 3(a), because they will most effectively prevent the outdiffusion of Li⁺ from the LiNbO₃ substrate into the buffer oxide during annealing. As a result, the amount of Li⁺ ions in the oxide buffer layer will be reduced. However, the F-ions will also be useful if they are deposited within the oxide buffer layer or even at the top surface of the buffer layer (but underneath the electrodes and CDL layer, as shown in FIGS. 3(b) and 3(c)). Since these trapping layers typically have a lower refractive index than the waveguide material, effects on light propagation thru the waveguide is not a concern. The added benefit of using such F-containing layers is that they have a much lower dielectric constant, which helps lower the overall RF losses of signals in the buffer layer.

After these organic F-containing Li trapping layers are laid down, it is preferably baked to facilitate the Li—F reaction to form LiF. The preferred temperature and time of such baking is 100-500° C., and for a duration of 0.1-20 hours. The atmosphere for such baking treatment can be oxygen, air or inert gas such as argon. The preferred thickness of such layers is 0.1-1 μm.

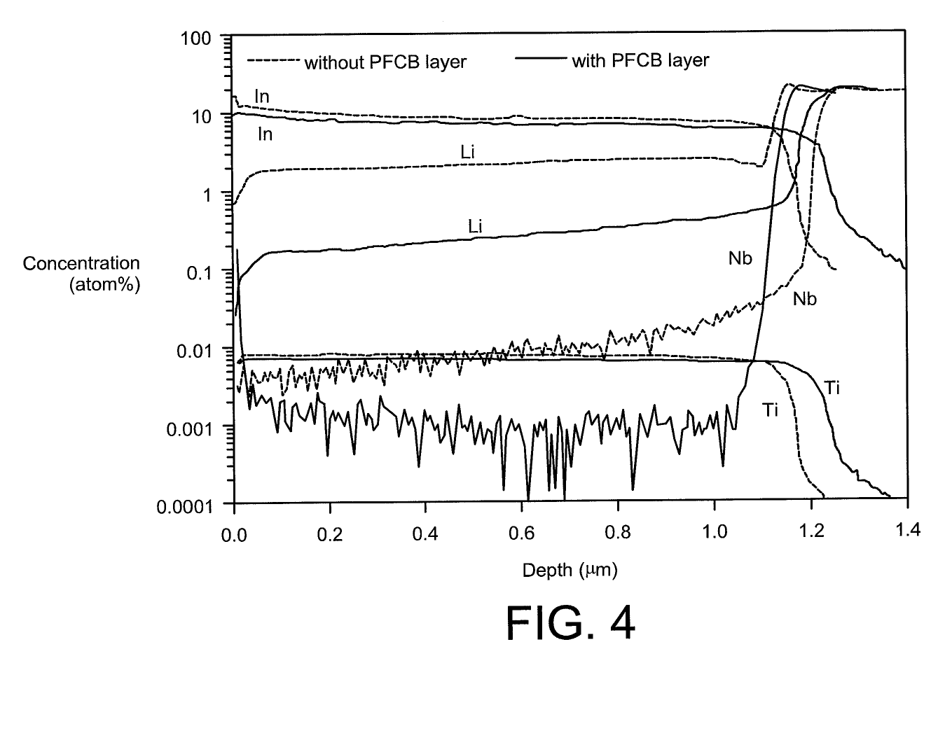

FIG. 4 shows the compositional depth profiles across the oxide buffer layer for samples with and without a Li-trapping F-containing layer after annealing at 500° C. for 5 hours in wet oxygen. For the sample with a PFCB layer deposited at the oxide/substrate interface, the Li concentration is one order of magnitude lower than that in the sample without any trapping layer. This clearly demonstrates the effectiveness of such a trapping layer in immobilizing the Li ions by forming the LiF compound, thus minimizing the outdiffusion of Li from the LiNbO₃ substrate into the oxide buffer layer during annealing.

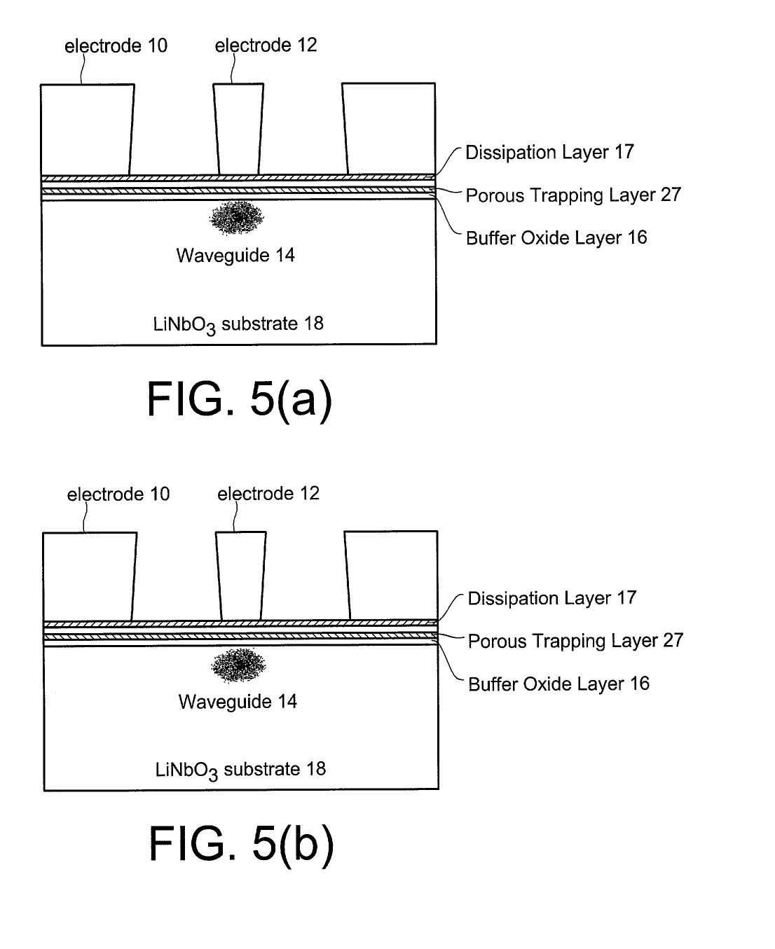

FIGS. 5(a) and (b)illustrate other embodiments of the present invention, where a porous Li-trapping layer 27 is used. Such materials have an open structure with a large surface area-to-volume ratio that can be used to absorb and neutralize Li ions. In particular, carbon nanotubes may be used, which are composed of concentric graphitic tubules with diameters 1-100 nm and lengths of the order of several micrometers. It has been shown that alkali metals can be intercalated into the inter-shell van der Waals spaces in multiwall nanotubes. In single wall nanotube bundles, the metal can occupy the interstitial sites between the single wall nanotubes within the bundles. The saturation alkali metal composition is reported to be MC₆ (M=K, Rb and Cs), the same as that in graphite. However, the intercalation capacity (amount of Li intercalated per unit of carbon) for Li in nanotubes is higher (saturation composition is reported to be Li_{1.7}C₆) than that in graphite. Mechanical ball-milling or ultrasonic treatment of nanotubes, which introduces defects and disorder into the nanotube structure and also cut the nanotubes in shorter segments, can further enhances the Li capacity (Li_{2.4}C₆). The unusually large Li capacity in nanotubes is believed to be related to the possible formations of Li₂ covalent molecules and the Li—C—H bonds.

Carbon nanotubes can be prepared by a number of techniques, including carbon-arc discharges, chemical vapor deposition via catalytic pyrolysis of hydrocarbons, laser ablation of catalytic metal-containing graphite target and condensed-phase electrolysis. Depending on the method of preparation and the specific process parameters which essentially control the degree of graphitization, the helicity and the diameter of the tubules, the nanotubes can be produced in the form of either multi-walled, single-walled or as bundles of single-walled tubules and can adopt various shapes such as straight, curved, planar-spiral and helix. To have nanotubes function as Li-trapping layers 27 on a LiNbO₃ modulator device, nanotube powders may be mixed with a solvent to form a solution or slurry. The mixture can then be screen printed or dispersed (by spray, spin-on, electrophoresis, etc.) onto the buffer oxide to form a Li-absorbing layer 27. Annealing in either air, vacuum or inert atmosphere can be followed to drive out the solvent, leaving a pure nanotube layer 27 that is suitable for Li trapping. To improve adhesion, nanotubes can also be mixed with polymer binder during processing.

The nanotube layer 27 is preferred to be placed within or at the top of the oxide buffer layer 16 (see FIGS. 5(a) and 5(b)), not at the buffer/substrate interface. This is because nanotubes are optically absorbing, which can distort optical signal and cause optical losses when light travels in the waveguide. The preferred thickness of such a layer 27 is 0.1-1 μm.

It is understood that the above-described embodiments are illustrative of only a few of the many possible specific embodiments, which can represent applications of the invention. It is further understood that various combinations of features of the above exemplary embodiments, although not expressly set forth, are also within the knowledge of one of ordinary skill in the art. Further, numerous and varied other arrangements can be made by those skilled in the art without departing from the spirit and scope of the invention.

1. A process for manufacturing an electrooptic device, comprising:
depositing a buffer layer on a substrate with a waveguide therein; and
depositing a fluorine-containing active barrier layer.

2. The process of claim 1, wherein the fluorine-containing active barrier layer is deposited at the buffer layer/substrate interface.

3. The process of claim 1, wherein the fluorine-containing active barrier layer is deposited within the buffer layer.

4. The process of claim 1, wherein the fluorine-containing active barrier layer is deposited on top of the buffer layer.

5. The process of claim 1, further comprising:
depositing a charge dissipation layer on the buffer layer; and
forming at least two electrodes on the charge dissipation layer.

6. The process of claim 1, wherein the fluorine-containing active barrier layer includes one of a fluorinated Si oxide, Si nitride or Si oxynitride based material, an amorphous fluorinated carbon, or a fluorinated polymer.

7. The process of claim 1, wherein the substrate is made of one of LiNbO₃ or LiTaO₃.

8. The process of claim 1, further comprising:
baking the fluorine-containing active barrier layer.

9. The process of claim 1, wherein said baking step is performed at a temperature of 100-500° C. and for a duration of 0.1-20 hours in an atmosphere of oxygen, air or inert gas and produces a fluorine-containing active barrier layer having thickness of 0.1-1 μm.

10. An electrooptic device, comprising:
a substrate with a waveguide therein, formed of an electrooptic material;
a buffer layer; and
a fluorine-containing active barrier layer.

11. The electrooptic device of claim 10, wherein the fluorine-containing active barrier layer is deposited at the buffer layer/substrate interface.

12. The electrooptic device of claim 10, wherein the fluorine-containing active barrier layer is deposited within the buffer layer.

13. The electrooptic device of claim 10, wherein the fluorine-containing active barrier layer is deposited on top of the buffer layer.

14. The electrooptic device of claim 10, further comprising:
depositing a charge dissipation layer on the buffer layer; and
forming at least two electrodes on the charge dissipation layer.

15. The electrooptic device of claim 10, wherein the fluorine-containing active barrier layer includes one of a fluorinated Si oxide, Si nitride or Si oxynitride based material, an amorphous fluorinated carbon, or a fluorinated polymer.

16. The electrooptic device of claim 10, wherein the substrate is made of one of LiNbO₃ or LiTaO₃.

17. A process for manufacturing an electrooptic device, comprising:
depositing a buffer layer on a substrate with a waveguide therein; and
depositing a porous trapping layer.

18. The process of claim 17, wherein the porous trapping layer is deposited at the buffer layer/substrate interface.

19. The process of claim 17, wherein the porous trapping layer is deposited within the buffer layer.

20. The process of claim 17, wherein the porous trapping layer is deposited on top of the buffer layer.

21. The process of claim 17, further comprising:
depositing a charge dissipation layer on the buffer layer; and
forming at least two electrodes on the charge dissipation layer.

22. The process of claim 17, wherein the porous trapping layer includes carbon nanotubes.

23. The process of claim 17, wherein the substrate is made of one of LiNbO₃ or LiTaO₃.

24. An electrooptic device, comprising:
a substrate with a waveguide therein, formed of an electrooptic material;
a buffer layer; and
a porous trapping layer.

25. The electrooptic device of claim 24, wherein the porous trapping layer is deposited at the buffer layer/substrate interface.

26. The electrooptic device of claim 24, wherein the porous trapping layer is deposited within the buffer layer.

27. The electrooptic device of claim 24, wherein the porous trapping layer is deposited on top of the buffer layer.

28. The electrooptic device of claim 24, further comprising:
depositing a charge dissipation layer on the buffer layer; and
forming at least two electrodes on the charge dissipation layer.

29. The electrooptic device of claim 24, wherein the porous trapping layer includes carbon nanotubes.

30. The electrooptic device of claim 24, wherein the substrate is made of one of LiNbO₃ or LiTaO₃.
